(19) United States
(12) Patent Application Publication
(10) Pub. No.: US 2014/0324779 A1
(43) Pub. Date: Oct. 30, 2014

(54) TRAVEL APPLICATION FOR MOBILE DEVICES

(71) Applicant: FREERUN TECHNOLOGIES, INC., Napa, CA (US)

(72) Inventors: Frank FORBES, Napa, CA (US); Benjamin Jared Franz, Napa, CA (US)

(73) Assignee: Freerun Technologies, Inc., Napa, CA (US)

(21) Appl. No.: 13/873,179

(22) Filed: Apr. 29, 2013

(51) Int. Cl. G06F 17/30

(52) U.S. Cl. CPC G06F 17/30575
USPC 707/634

(57) ABSTRACT

A travel application for a mobile device is described. The travel application can include an application database which resides on the mobile device and application code for processing instructions stored in the application database, such as instructions for creating pages of information output via the travel application on the mobile device. Without recompiling or reinstalling the travel application on the mobile device, via updates to the travel application database, the navigation structure of the travel application can be changed, a travel data section can be added or removed, a filter for an existing travel data section can be added or removed and the output structure for any of the plurality interface states associated with the travel application can be modified. By executing from an application database stored locally on the mobile device, the travel application can provide some amount of guaranteed functionality when network access is unavailable.

### FIELD OF THE INVENTION

This invention generally relates to executable applications for mobile devices, and more particularly to applications for providing travel and event information on a mobile device.

### BACKGROUND

Most mobile devices which are available today include native processors and one or more network interfaces. Using the native processors, many applications are executed which use only information residing on the mobile device such that a network interface is not required. For example, the information necessary for execution can be integrated as part of the application. Alternatively, applications, such as a web-browser, are executed which require information transmitted from a remote device in addition to information residing on the mobile device. In this instance, a network interface and working communication connection is required to receive information from the remote device to enable proper execution of the applications.

An advantage of executing an application using information residing on the mobile device, such as using information integrated into the executed application, is that the application performance is not affected by network performance issues, such as a poor network signal or a congestion level on the network. A disadvantage of this approach is that to change application features, such as features that require new information, a new version of the application has to be downloaded and installed. For example, the application may be downloaded from a code repository associated with the iOS™ or Android™ operating systems and installed to implement the new features requiring the new information.

When an application, which is configured to operate mostly in an off-line manner, is downloaded in its entirety, the download size is large. The download size depends on the overall size of the application. For small changes to the application, a large portion of the download is wasted because most of the application has not changed.

In some scenarios, a mobile device is operated in an area where network coverage is limited using an application which requires frequent but small updates. Because of the network issues, it is desirable to operate in an off-line mode. However, an application configured for off-line operations, which requires a download of a new version to implement each update, is problematic because each update requires an entire download of the application. These frequent large downloads are annoying to users.

Conversely, when the application is configured for on-line operations, where information is maintained off-line and retrieved on demand, the need for frequent version updates of the application is lessened. However, the network issues sometimes cause the application not to function properly. For example, the application, because of a lack of a network signal, may not be able to retrieve information needed for a particular function. The application not functioning properly in these situations is also frustrating and annoying to users. In view of the above, improved methods and apparatus are needed for mobile applications configured for on-line and off-line operations in areas with network performance problems.

### SUMMARY

A travel application for a mobile device is described. The travel application can be downloaded from a third-party code repository. The travel application can include an application database which resides on the mobile device and application code for processing instructions stored in the application database, such as instructions for creating pages of information output via the travel application on the mobile device. By executing from an application database stored locally on the mobile device, the travel application can provide some amount of guaranteed functionality when network access is unavailable.

The travel application database can include information which specifies the interface states which can be output from the travel applications including how each of the interface states is to be assembled, what information is to output as part of each interface state as well as the allowable transitions to other interface states from each interface state. The architecture allows updates to the application database to significantly change features of the application, such as but not limited to the content which is output, the look and feel of the presentation of the content when it is output and the navigation structure of the application. These changes can be implemented without downloading a new version of the application from a code repository. This feature can be important in situations where changes are needed to the output structure of the travel application because of time sensitive events.

The download size associated with the update of the application database can be minimized by performing incremental updates where only portions of the database which have been modified are downloaded. Using the architecture, features of the application can be easily changed and the information associated with the application can be kept current while limiting the effects of network performance on the application performance or the effects of a long review process needed before a new version of the application can be pushed out. In one embodiment, a versioning system can be utilized for determining which incremental changes are needed to update an old version of the travel application database to a new version.

Aspects of the travel application are related to non-transitory computer readable medium for storing a computer program used by a mobile device where the computer program can be executed by a processor on the mobile device to generate features of the travel application. The computer readable medium can include computer code for generating a plurality of interface states for the travel application output via the mobile device using only information stored locally in a travel application database in a memory on the mobile device and computer code for syncing the travel application database on the mobile device with a remote travel application database on a server maintained separately from the code repository. The travel application database can initially be downloaded from a third-party code repository. The travel application database can include a) an output structure for each of the plurality of interface states in the travel application; b) a navigation structure specifying one or more of the plurality of interface states which are reachable from each of the plurality interface states in the travel application; c) a plurality of resources including electronic media files and templates in a scripting language for use in generating the output structure for each of the plurality of interface states and d) a plurality of travel data sections each travel data section including records associated with a category of travel related information and information specifying filters for use only with the records in the travel data section. Without recompiling or reinstalling the travel application on the mobile device, via the syncing, the navigation structure of the travel application can be changed, a travel data section can be added or removed, a filter for an existing travel data section can be added or removed and the output structure for any of the plurality interface states can be modified.

### BRIEF DESCRIPTION OF THE DRAWINGS

The included drawings are for illustrative purposes and serve only to provide examples of possible structures and process steps for the disclosed inventive systems and methods for providing game services to remote clients. These drawings in no way limit any changes in form and detail that may be made to the invention by one skilled in the art without departing from the spirit and scope of the invention.

FIG. 1 is a block diagram of a system for distributing, managing and executing a mobile application in accordance with the described embodiments.

FIG. 2 is a block diagram of system where an output structure of a mobile application is modified via an application database update in accordance with the described embodiments.

FIG. 3 is a block diagram of a navigation structure for a mobile application in accordance with the described embodiments.

FIG. 4 is a block diagram of navigation structure for a leaf page in a mobile application in accordance with the described embodiments.

FIG. 5 is a block diagram of a navigation structure for a mobile travel application in accordance with the described embodiments.

FIG. 6 is an illustration of a home page of a travel application output on a mobile device in accordance with the described embodiments.

FIG. 7 is an illustration of a calendar page of a travel application output on a mobile device in accordance with the described embodiments.

FIG. 8 is an illustration of a page of a travel application output on a mobile device in response to a selection of a filter button in FIG. 7 in accordance with the described embodiments.

FIG. 9 is an illustration of an event page of a travel application output on a mobile device in accordance with the described embodiments.

FIG. 10 is an illustration of a page with offer categories from a travel application output on a mobile device in accordance with the described embodiments.

FIG. 11 is an illustration of a page with a listing of dining offers from a travel application output on a mobile device in accordance with the described embodiments.

FIG. 12 is an illustration of a page with a listing of wineries from a travel application output on a mobile device in accordance with the described embodiments.

FIG. 13 is an illustration of a first page which allows adjustment of filter settings associated with wineries from a travel application output on a mobile device in accordance with the described embodiments.

FIG. 14 is an illustration of a second page which allows adjustment of filter settings associated with wineries from a travel application output on a mobile device in accordance with the described embodiments.

FIG. 15 is an illustration of a page, including winery information and a navigation link to offers associated with the winery, from a travel application output on a mobile device in accordance with the described embodiments.

FIG. 16 is an illustration of a favorites page from a travel application output on a mobile device in accordance with the described embodiments.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Travel focused applications are popular with mobile device users. A good travel application can provide a user with up-to-date information regarding travel related subjects, such as attractions, events, food, lodging, tours and shopping which greatly enrich the travel experience. For example, the travel application can provide up-to-date information associated with a change to an event, such as but not limited to a weather related schedule change, a schedule change associated with a business operating outside of normal parameters, such as the business being closed because the owner is on vacation or offers from food and lodging providers which are time limited and thus, regularly expire. Thus, the information provided from the travel application can allow a user to adjust their trip itinerary in a spontaneous manner and avoid pitfalls associated with out-of-date information, such as traveling to an attraction which is not open on a particular day.

During a trip, when a user will want information from their travel application and where they will be at the time when the want arises is unpredictable. For example, the user can be at their hotel, at a restaurant or driving in the countryside when a decision is made to utilize the travel application. When the user is at a location where network performance is poor or unavailable and their travel application requires a network connection to function properly, the travel application may not deliver the requested information. If this happens frequently, the user is likely to become frustrated, will not use it in the future, will not recommend it and may possibly give it a poor review.

When the travel application doesn't require a network connection and operates mostly in an off-line mode, the user may still have to frequently download new versions of the travel application to keep the information current and valid when it operates in an off-line mode. A user can become frustrated with constantly having to download new versions of the application because the network bandwidth may be small which results in a time consuming download process. Thus, the user may not keep the application current. When the application is not kept current, the user may receive information which is not valid and may again become frustrated with application.

In addition, when a code repository, such as the appstore by Apple™ is utilized to distribute the application, each version usually has to be submitted to a review process before it can be released. A review of a new version of an application can take weeks. Thus, in a situation where new information needs to be reflected immediately in an application, such as a result of an unpredicted weather related issue, it may not be possible to push a version of the application out in a manner timely enough for the new information to be useful. In fact, by the time the new version is approved, the newly added information may no longer be valid.

As described as follows, method and apparatus that are applicable to travel applications, which address some of the issues above related to on-line and off-line operation and keeping the information associated with the application current, are described. Although the methods and apparatus are primarily described in the context of a travel application, the methods and apparatus can be applied to other types of mobile applications and the example of a travel application is provided for the purposes of illustration only.

The mobile travel application can include an application database which resides on the mobile device from which the application executes. The architecture allows updates to the application database to significantly change features of the application, such as but not limited to the content which is output, the look and feel of the presentation of the content when it is output and the navigation structure of the application. These changes can be implemented without downloading a new version of the application from a code repository. The download size associated with the update of the application database can be minimized by performing incremental updates where only portions of the database which have been modified are downloaded. Using the architecture, features of the application can be easily changed and the information associated with the application can be kept current while limiting the effects of network performance on the application performance or the effects of a long review process needed before a new version of the application can be pushed out.

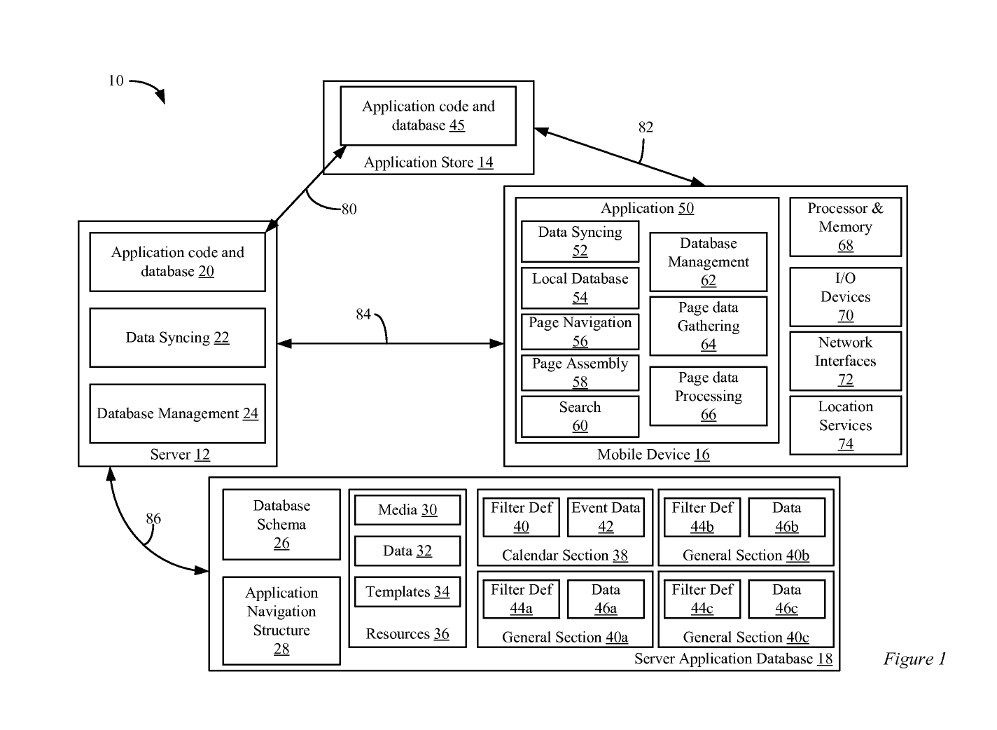

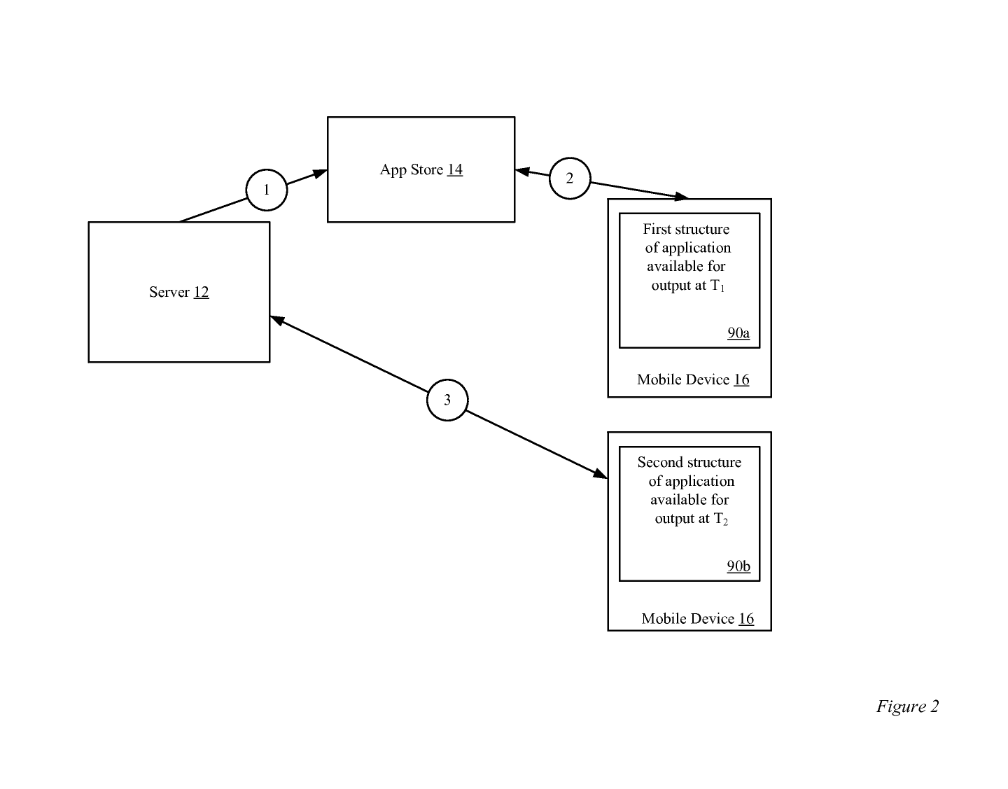

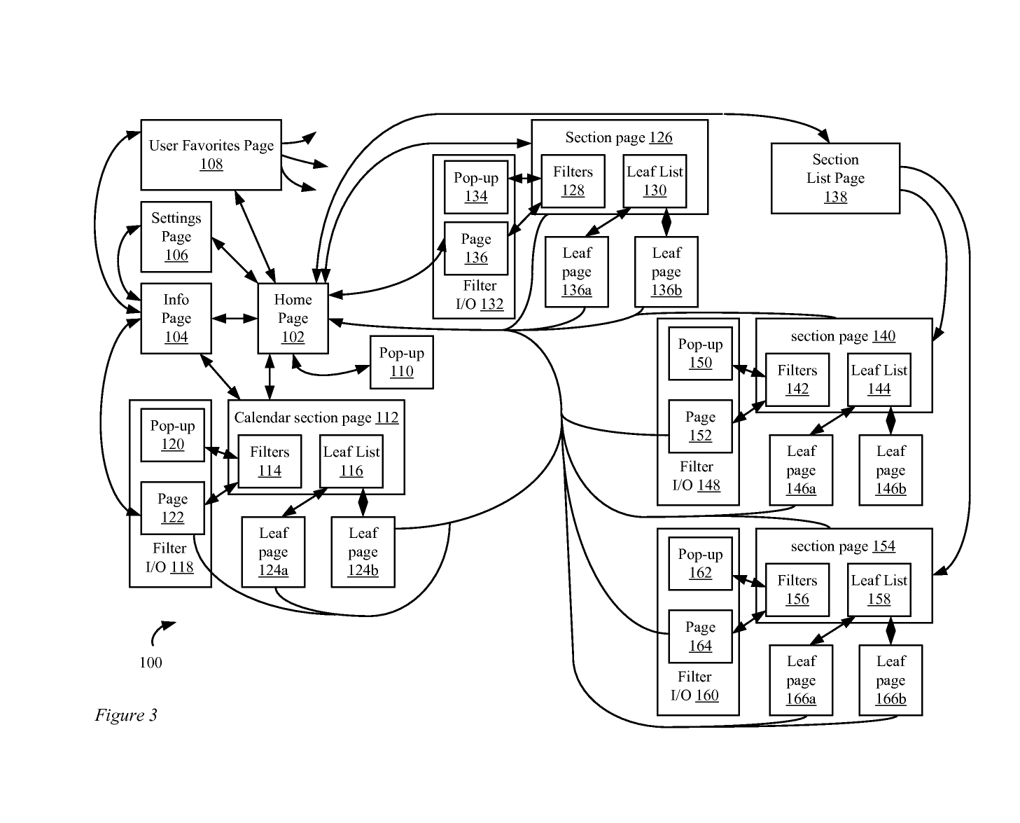

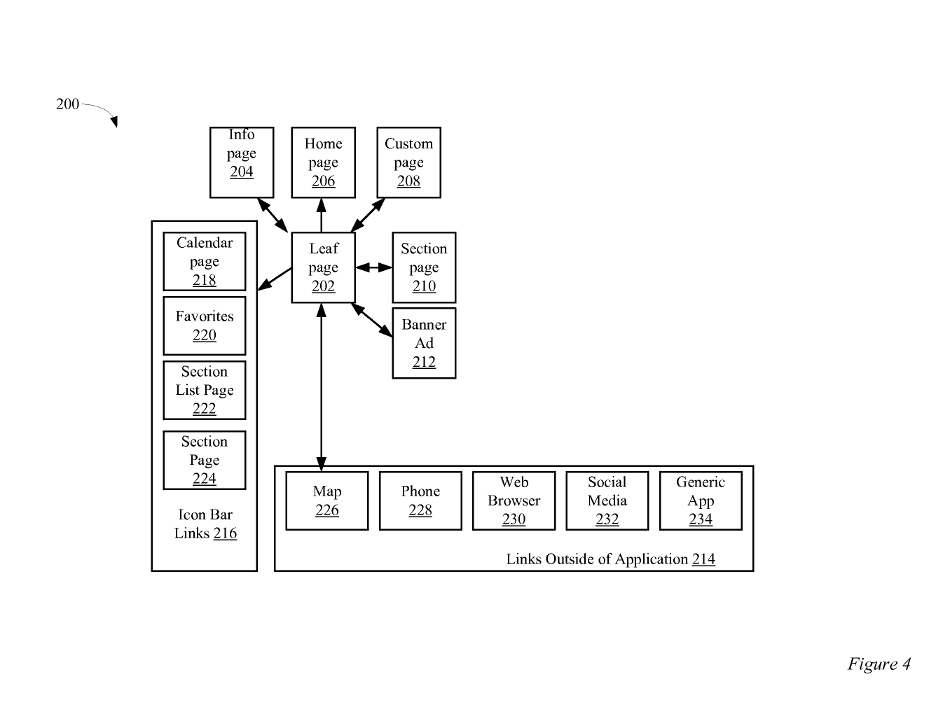

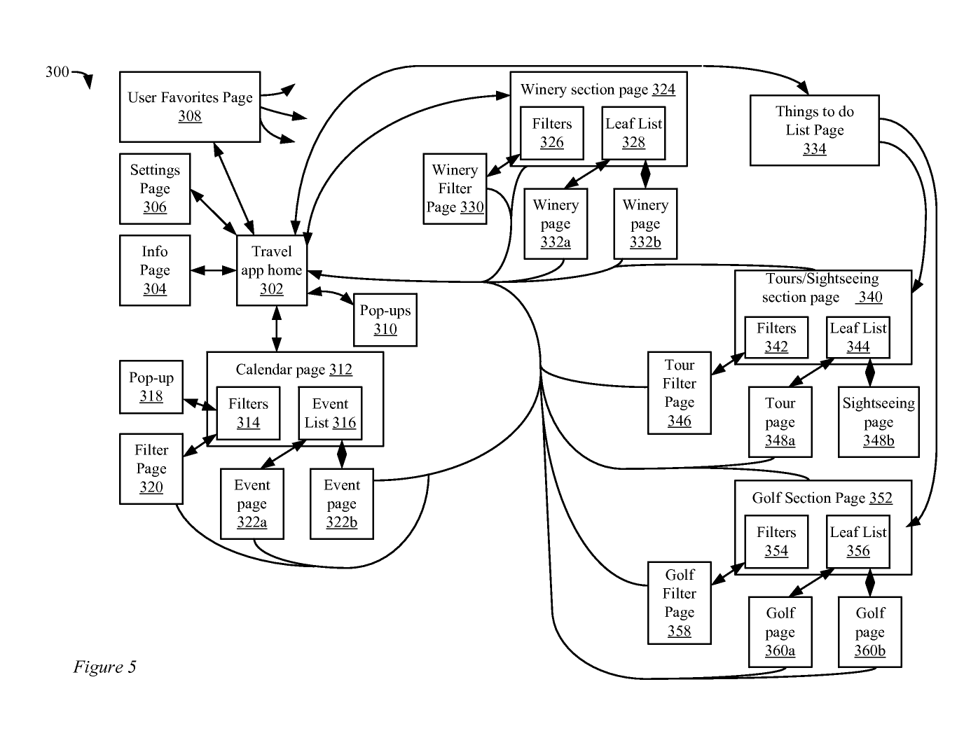

In more detail, with respect to FIG. 1, a system for distributing managing and executing a mobile application are described. In particular, details of the application structure including its database structure are discussed with respect to FIG. 1. With respect to FIG. 2, examples of how the output of the mobile application is modified in response to an update of the application database update described. With respect to FIGS. 3, 4 and 5, an exemplary navigational structure of the mobile application is discussed. In particular with respect to FIGS. 3 and 4, a general navigation structure is described and with respect to FIG. 5 a navigational structure more focused on a travel application is discussed. With respect to FIGS. 6-16, illustrations of a mobile device outputting content associated with various states of a travel application using the architecture described herein is described.

### System and Database Architecture

In this section, embodiments of software architecture for an application executed on a mobile device are described. Further, a system for providing the application software and updating an application database associated with the mobile application are discussed. FIG. 1 is a block diagram of a system 10 for distributing, managing and executing a mobile application 40 for a mobile device 16. In FIG. 1, a system 10 including a server 12, an application store 14 which functions as a code repository and a mobile device 16 are shown. The server 12, the application store 14 and mobile device 16 can each include processors, memory, network interfaces and input/output devices which allow associated users to interact with each device and allow the devices to communicate with one another.

The mobile device 16 can be a portable electronic device, such as but not limited to a laptop computer, a tablet computer, a smart phone or a netbook computer. The mobile device 16 can include a processor and memory 68 which are used to execute applications, such as application 50. In addition, the mobile device can include input and output devices, such as but not limited to displays, a touchpad, a touch screen, a keyboard, a speaker, a microphone, an image capture devices, lighting devices, a global positioning system sensor and other types of sensors (e.g., accelerometers, tilt detectors, light, etc.). The application 50 can be configured to receive input from or send output to the I/O devices 70.

The mobile device 16 can execute many different types of applications. For example, the mobile device 16 can execute a mapping application, a web-browser application, an e-mail application, a phone application and a texting application. In some embodiments, described in more detail below, some of these applications can be accessed from within application 50 and then executed. For example, a user may be able to initiate a call or a purchase from within application 50.

The mobile device 16 can include a number of different network interfaces, such as wireless and wired interfaces, which allow the mobile device to connect to another device, a local area network (e.g., a hotspot) or a wide area network (e.g., the Internet). For example, the mobile device 16 may be able to establish communications with cellular network using a cellular communication protocol or access a local Internet hotspot via a Wi-Fi communication connection or using some other type of wireless protocol. The mobile device may utilize a number of location services 74 to determine an approximate location of the mobile device 16. For example, using a GPS sensor, communications with cellular towers, communications with Wi-Fi hot spots or combinations thereof, the mobile device 16 can be configured to determine its current location. When application 50 is a travel application, the location data can be used for sorting purposes, such as sorting items according to a distance from the determined location of the mobile device 16.

In one embodiment, the application 50 can be configured to always execute using the local application database 54 residing on the mobile device 16. If the application determines new information is needed, a sync operation can be triggered and then an update of the local application database can be performed. Then, the application can continue executing from the local application database. Thus, the application can continue operate any time network connectivity is lost or turned off by the user.

The application store 14 can be a code repository where applications executable on mobile device 16 are stored and made available for purchase and download. For example, various mobile phone manufactures maintain application stores that are compatible with an operating system executed by the phone, such as but not limited to iOS by Apple™, Android flavors by Google™, Blackberry OS by RIM™ and Windows mobile by Microsoft™. In operation, a communication connection, such as 82, can be established between the mobile device 16 and the application store 14. The application store 14 can be implemented on dedicated or cloud servers. From the application store 14, applications, such as versions of application 50, can be downloaded to the mobile device 16. The process can be regularly repeated as versions of the application at the application store 14 are changed and then downloaded to device 16.

The server 12 can maintain application code and an application database. In one embodiment, the database 18 can reside on server 12. In another embodiment, the database 18 can reside on a separate device which communicates with server 12 via some communication connection, such as 18. In some embodiments, multiple servers and multiple databases can be instantiated on different devices which provide services to applications executed on mobile devices.

Periodically, via communication connection 80, the server 12 can be configured to upload new versions of the application 50 which may include modifications to the application database. In one embodiment, the server 12 can be configured to download new copies of the application including the application database directly to the mobile device 16, such as via network connection 84. In other embodiments, the server 12 can be configured to maintain an application database which is regularly updated on the server 12 and then sync the database 12 with mobile devices including application 50 which contact the server 12.

In some embodiments, since the application store 14 requires a lengthy review process before a new version of the application code and database 45 can be placed on the application store. The application database version for the application 45 at the application store may be different that the application database version 18 maintained at server 12. Thus, after the application 45 from the application store is downloaded to the mobile device 16, the mobile device 16 can communicate with the server 12 to sync its local database 54 with the latest database version on sever 12.

The syncing can involve determining the changes from version of the application database 18 on server 12 as compared to the application database 54 residing on the mobile device 16. The differences can vary from device to device depending on the last time the local application database, such as 54, on the device was updated. Once the differences are determined, the server 12 can determine an update of information to the local database 54 which syncs the local database 54 with the server application database 18. Then, the server 12 can send the information needed for the update to the mobile device 18. The data syncing component executed on server 22 can be configured to implement these functions.

When the differences are small, the amount of data which is sent is also small. As the differences increase, then the amount data transferred will increase. The maximum amount of data which can be expected to be transferred is the entire contents a version of database 18. A transfer of the entire database may occur when the differences are so large that the server 12 can't figure out the incremental changes needed to update database 54 or the database 54 on mobile device has been corrupted in some manner. In one embodiment, if a time since the update exceeds some threshold value, the server 12 may automatically update the entire database.

In one embodiment, the server 12 can maintain version numbers for each version of the application database as well as databases associate with each version for some number of versions. Each time the application database is updated, the server 12 can store the changes needed to convert from the last version to the current version. Further, the server 12 can determine what changes are needed to go between different versions, such as from version one to version six, from version two to version five, from version one to version three, etc., and save a record of these changes. Thus, each time a different mobile device contacts server 12, the mobile device, such as 16, can provide its database version number and then based upon the received version number, the server 16 can attempt to lookup whether the changes between the version numbers have been previously determined and are available. When the changes are available, the server 12 can download instructions and data to the mobile device 16 in a format that allows the application 50 to sync the local database 54 with the current version on the server 12.

When the changes are not available, the server can attempt to determine what changes need to be made. For example, the server 12 can compare the current database with the old version of the database and/or the server can examine all of the incremental changes which have been made between the old version residing on the mobile device and the current version on the server 12. When the necessary changes are determined, the server can download the needed changes and the current version number of the database so that it can be updated on the mobile device. When the sync is successful, the application 50 can update the version number for the local database. For the next sync procedure involving the mobile device 16, the server 12 can use the version number that was sent with the last sync procedure.

In particular embodiments, a syncing request from a mobile device can include one or more of a software version number of the application 50, a type of device (e.g., Ipad, Samsung Galaxy, etc.), and operating system, when the last update occurred, a database schema version, display information (e.g., pixel resolution in each direction and a dpi), a requested action (e.g., update database), a scope of the request excluding event data (e.g., a full reload or a reload of data since last update) and a scope of the request for event data (e.g., events for a specific data range). Via the syncing request, in one embodiment, only event data may be updated in the database. In other embodiments, only other components of the database, such as filters and navigation information may be updated. Filters and navigation information are described in more detail below.

In various embodiments, the updates can be device specific. Thus, device information, such as the type of device and its operating system can be provided. The application can be configured to output different types of visual information, such as still or moving images. In one embodiment, based upon the resolution of the display on the mobile device, different content can be sent which is most suitable for the particular device. For example, iPad™ with a high-resolution display can be sent higher resolution content than an iPhone™ using a lower resolution display. It may not be possible to match exactly the resolution of each type of display which is available. Thus, in some instances, the application can be configured to interpolate video content according to the resolution of the display on which it is to be displayed.

In one embodiment, it may not be possible to update the mobile device 16 with the latest version of a database maintained on server 12. For example, the application code can be configured to recognize particular data formats, such as formats associated with images, audio files, video files, scripting languages etc., which are included in the database. The formats that are recognized may change from version to version of the application code. Thus, an older version of the application code may not be able utilize the latest version of the application database when it includes information in formats it can't process.

In these situations, in one embodiment, the server 12 can be configured to indicate it can't update the database. For example, a message can be displayed on the mobile device 16 indicating that a new version of the application code needs to be downloaded and installed before the application database can be update. In another embodiment, the server 12 can be configured to maintain different versions of the database that are compatible with different versions of the application code. Thus, the latest version of the application database for a first version of the application code can be different than the latest version of the application database for the second version of the application code.

In yet another embodiment, the server 12 may attempt to perform a partial update of the application database 54. The server 12 can determine that the current version of the application code can still process certain types of data and then only update the compatible data. For example, the server 12 may be able to update event data for the application but not image data in certain formats.

Next, contents of the application database 54 for application 50 are discussed with respect to the database 18 maintained by the server. As described above, the application 50 and the server can be configured to sync these databases. In one embodiment, the database can include a database schema 26, the database schema specifies where different information is located in the database and how it is formatted. Using this information, the application 50 can determine the contents and structure of the database 54 so that it can be properly read. For example, the database schema can indicate that there is i) an application navigation structure section 28, ii) a resources section 36 including particular numbers of different resources of different types, such as media 30, data 32 and templates 34, and a description of each of the resources, iii) a calendar section 38 including filter definitions for the section and a format for event data (e.g., number of fields in each record, data type for each field, number of records in the section, names of each field in each record, etc.) included in the section and iv) three general sections, 40a, 40b and 40c including filter definitions, 44a, 44b and 44c, for each section and a format of data in each section (e.g., a type of section, number of fields in each record, data type for each field, number of records in the section, names of each field in each record, etc.).

The format of each section can vary from section to section. For example, section 40a can include records with twenty fields while section 40b can include records with fifteen fields. The number of records can vary from section to section. Further, the number of records can vary from database version to database version. Part of the update process can involve adding or removing individual records from each section. In addition, the number of sections can vary from database version to database version. For example, one version of the application database 54 can have only one general section while a second version of the application database can have five general sections.

Part of the update process may involve replacing one section with another section, adding one or more additional sections or removing one or more sections. Further, individual records in each section can be added or removed. The server 12 can send instructions to the mobile device 16 which are processed by the application 50 which cause the application database to be updated according to the instructions.

The application 50 can be configured to generate a number of interface states which are output on the mobile device 16. The interface states can be output in different formats on the mobile device 16 involving visual, auditory or haptic (e.g., vibration) components. In one embodiment, each interface state can be generated with a visual page of information. Particular actions can be allowed from each interface state, such as but not limited to inputting data, causing the application 50 to access an another application (e.g., a browser application, a mapping application or a communication application), performing a search of data within a section or causing the application to generate a different interface state, such as by selecting a navigation link in the current interface state.

The navigation structure 28 defines what other interface states can be reached from each interface state. In one embodiment, a home state can be reached from each interface state except the home state. For example, visually formatted interface pages can include a selectable image that when selected causes the application to generate the home state. In another example, the application can process a voice command, such as “home” which causes the application to output the home state.

In another embodiment, an icon bar can be included on many of the visual components for interface states. The icon bar can include links to some finite number of states within the interface. For example, the icon bar can include a link to a favorites page interface state. When the application 50 receives an indication (e.g., a touch input or a voice command) that an icon associated with the favorites page is selected from a first interface state, the application 50 can generate the favorites page interface state which includes favorite navigation links within the application 50 selected by a user. Additional details of the navigation structure are described below with respect to FIGS. 3, 4 and 5.

The server 12 can send commands to the mobile device 12 which cause the application 50 to alter all or a portion of the navigation structure stored in the local application database 54. When the application 50 is instantiated, the application code is configured to read information about the navigation and generate interface states where the transitions between the interface states is determined at least partially from the navigation structure defined in the local database 54. As described below, the user may have some influence over the navigation structure via the specification of favorites output in a favorites page.

The resource section 36 of the database 18 can include resources which the application 50 uses to construct its interface states. The resources can include media files, such as text, images or sounds which are used to generate an interface state. For example, an image can be used on a visual page that is generated as part of an interface state. Information defining each resource can be included. For example, the definition information can include a type of resource (e.g., text, image or audio), a format of the data used with the resource, a unique identification and other information that may be useful for using the resource. For example, an image file resource description can include its resolution height and width and its format (e.g., jpeg or .gif), a video file resource description can include its encoding (e.g., MP4 or WAV), its resolution, total size and length and audio file resource can include it encoding (e.g., MP3), size, length, etc.

In various embodiments, the resources can vary from database version to database version and syncing a database, such as 54, can involve removing or adding resources from the database. For example, an image file which is used for an icon in a page output by the application (e.g., an icon to represent a selectable link to a home page) can be deleted and replaced with a new image file. In another example, an image used to brand the application on the home page can be deleted and replaced with another image. This feature can allow the application to be branded to a particular company or even a temporary sponsor.

The server 12 can send commands to the mobile device 12 which cause the application 50 to add or remove one or more resources from the local application database 54. When the application 50 is instantiated, the application code is configured to read information about the resources and generate interface states which utilize the resources where the resources used by each interface state are defined in the local application database. By updating resources, the format in which information is presented, such as travel information from a particular record of information can be altered without recompiling the application code.

The template resource 34 can include instructions used to format an interface state output from the application. The instructions can be processed by the application 50 to generate the interface state, such as a visual page, on the mobile device 16. In one embodiment, the instructions can be in the form of a scripting language or a mark-up language which can be processed by the current version of the application code which is compiled on the mobile device. For example, a template format can be generated using HTML5, java script and CSS styling. HTML is an example of a markup language. Cascading Style Sheets (CSS) is a style language used for describing the presentation semantics (the look and formatting) of a document written in a markup language. CSS's most common application is to style web pages written in HTML and XHTML, but the language can also be applied to any kind of XML document, including plain XML, SVG and XUL. Other protocols can be utilized and these examples are provided for the purposes of illustration only.

In one embodiment, a template can be configured to receive an indication of whether the mobile device has on-line access or not. Depending on whether the device is on-line or not, the template output data in different formats. Alternatively, different templates can be utilized depending on whether the device has network access. In another embodiment, depending on whether a location of the device is available, the template can output data in a different format. For example, when the location is known, a list of items can be output on a page in an order based upon the distance from the location of the device. When the location is unknown, a list of items can be output in some other order, such as alphabetical order, according to the name of the item.

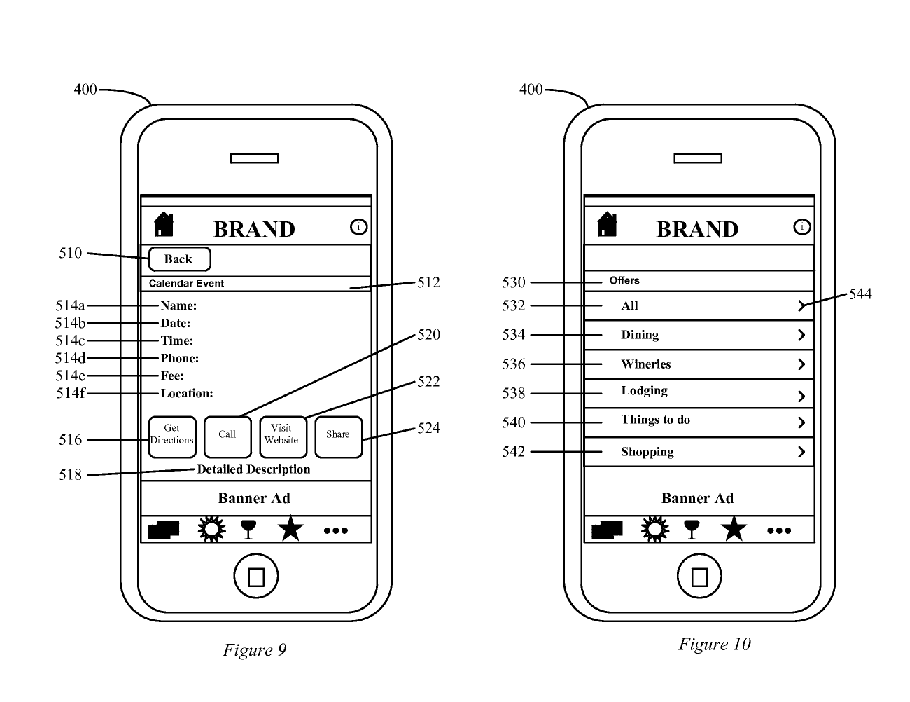

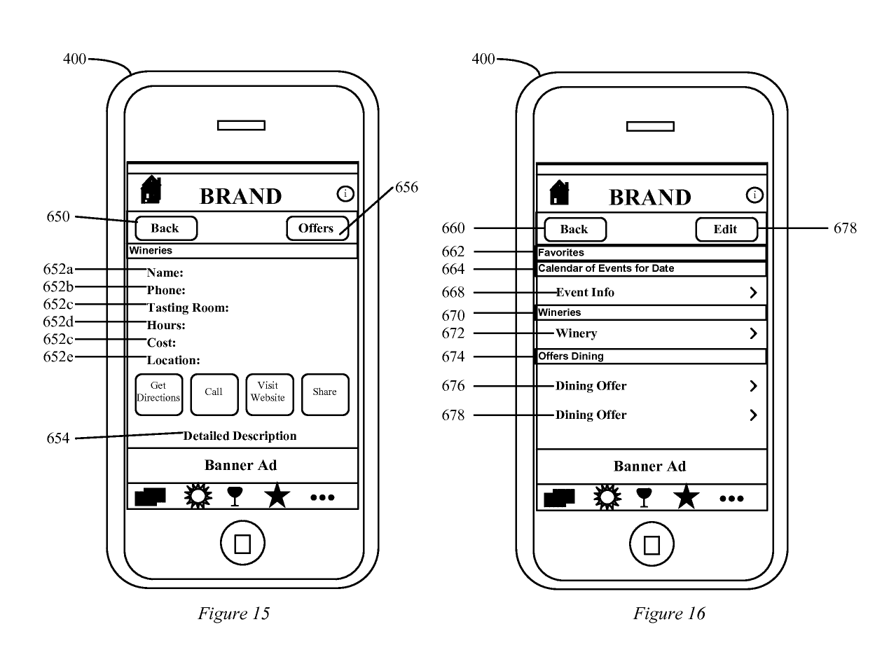

In a particular embodiment, a default template can be specified and used to output a visual page used to display information about a single record in a section. For example, each record associated with an event in the calendar section 38 can be output using the same template each time a user views details of the event (e.g., see FIG. 9). The information on the page can change from event to event because the data in the record changes. However, the format of each page remains the same. As another example, each record of data 46a in general section 40a can be output using a default format. FIG. 15 illustrates a template for a page which displays a record about a winery. Each page generated from a different winery record can be output with a similar format.

The application 50 can use the filter definitions to filter data within a section. The filter definitions can specify one or more fields within a record within a section on which the filter is based and additionally values which a filter can accept. For example, a record in the event data 42 can include one or more of an event id, a region name, an event frequency, an event fee, an event time, a date, an event description, a phone number, a longitude, a latitude, a geotag area, a start date, a start year, a start month, a start day, an end date, an end year, an end month, an end day, an event location, an event city, an event state, an event zip code, an event business name, a location area, tags for an ad banner and a custom template flag. This record definition can be useful for a travel application.

As another example, a record for the general section data (e.g., 46a, 46b and 46c) can include one or more of a display name for the record (e.g., generic winery, which is output in a listing of records), longitude, latitude, description, a start date (the record may not displayed unless the start date is exceeded), an end date (the record may not be displayed after the end date), an indicator of whether a custom template is to be used for the record, an identifier pointing to a section of the database where an offer associated with the record can be found, an identifier associated with the offer in the identified section and an offer template identifier which identifies a template for displaying the offer. This type of record can be used for different types of places, such as wineries, hotels, restaurants, shopping, tours, etc. found in a travel application.

Additional fields can be provided which vary from section to section. As an example, for a lodging section, a type of lodging field with values, such as “Bed and Breakfast,” or “Motor lodge,” can be included. As another example, for a restaurants section, a type of food field with values, such as American or Mexican, and a price range field with values, such as “$”, “$$”, “$$$” and “$$$$” can be included. For non-travel applications or other types of data different record format can be used.

In addition, as part of an update, the field structure of a particular section of data can be added or removed in response to instructions received from the remote server. For example, in a winery's section of data, a new field of data in each record can be added or an existing field can be removed and the definition of the section can be changed in response to the local database update. Further, a resource such as template, which is used to output a winery leaf page can be added as part of the update. Then, the application code can output interface states including the information in the fields added to each winery record or interface states without the information previously included the fields removed from each winery record without having to recompile the application code used to generate the interface states.

The custom template flag in the above records allows the default template for the section to be customized for the particular record. For example, a custom template can be specified for the particular record. The custom template may only be displayed when a page associated with the record pointing to the custom template is output from the application. If a custom template is not specified for a record, then the default template for the section is used for the record when it is output.

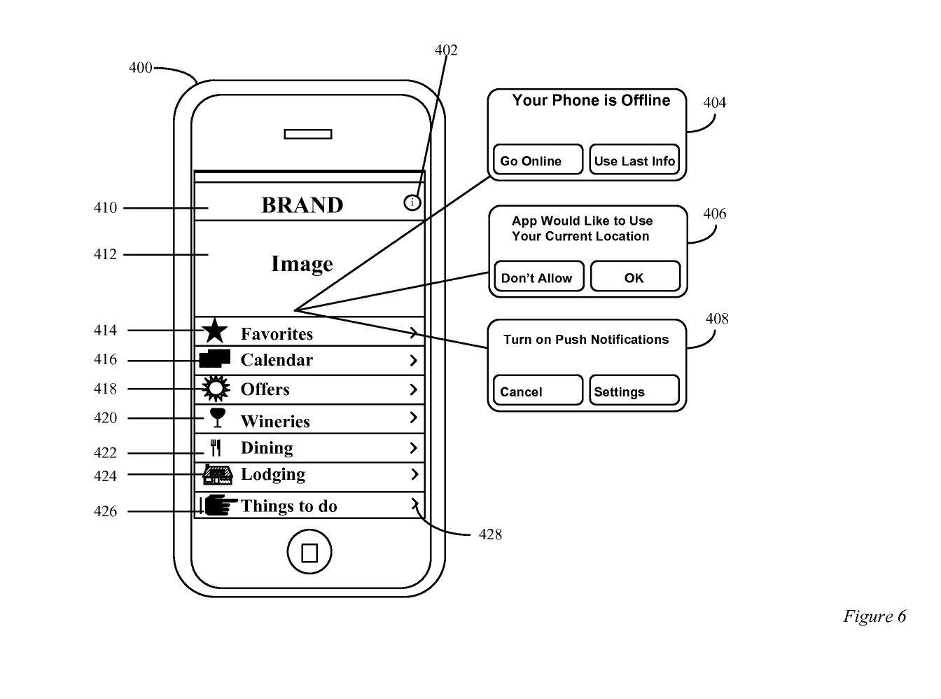

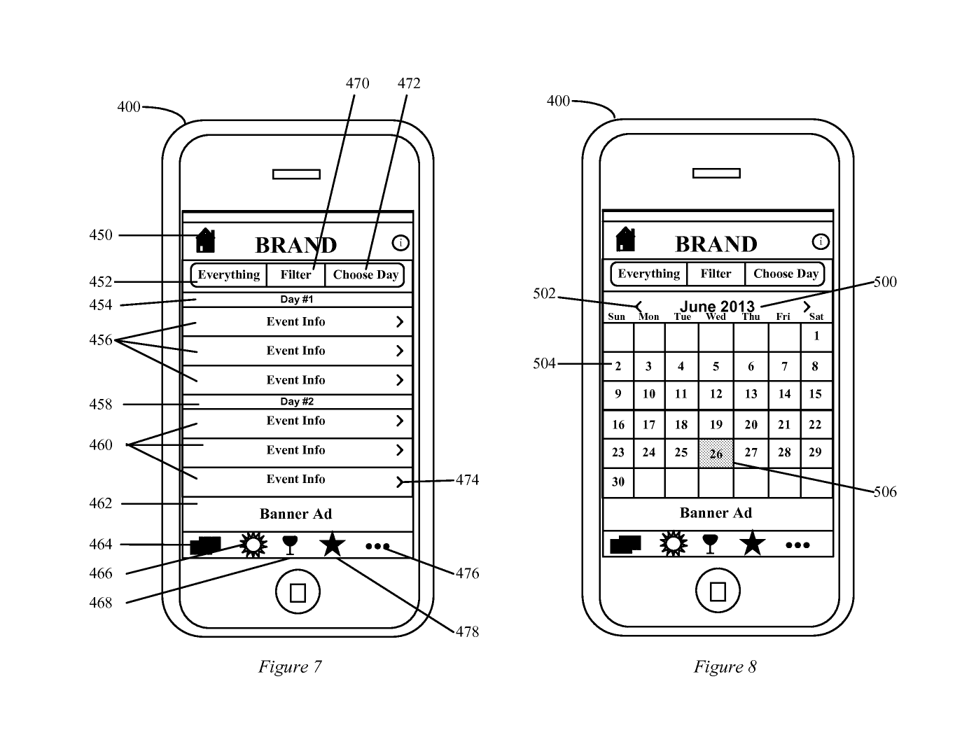

A filter definition can specify one or more fields to use for filtering data in a section Using one or more of the fields, a filter can applied and an associated filter page for setting filter parameters can be generated. Different filters can be specified for each section which are applicable only to the section. For example, a filter definition 40 can be specified for calendar section. The filter definition can specify one or more different fields in records including event data on which to base a filter. Typically, in the calendar section, at least one filter is based upon a date range (e.g., see FIGS. 7 and 8). However, additional filters can be specified on any other field in the record or combinations of fields, such as based upon an event fee or event fee and region, etc.

In another example, filter definitions, such as 44a, 44b and 44c, can be specified for each general section of data. For the general sections, the filters for each general section can be data independent such that the application doesn't have to know about the content of the data to perform the filtering. Thus, the filters can be specified using a similar process for each of the general sections even though the data in the fields of the records and length of the records may be totally different from section to section, such as wineries in one section and lodging in another section.

The server 12 can send commands to the mobile device 12 which cause the application 50 to add or remove one or more filter definitions from the local application database 54 where an update to the local application database doesn't require the application code which applies the filter definitions to the data which is output to be recompiled. The application code can be configured to read the filter definitions from the application database, generate interface states which allow the filter settings to be modified and apply the filter definitions when data is presented via the interface states in accordance with the filter settings.

The filters 40 for the calendar section may differ slightly from filters of other sections because sorting is done based upon dates. Thus, for the calendar filters, some of the filters can be based upon knowing the data is date and needs to be handled as such. Other filters for the calendar section can be more general where knowledge of the type of content which is being filtered is not required.

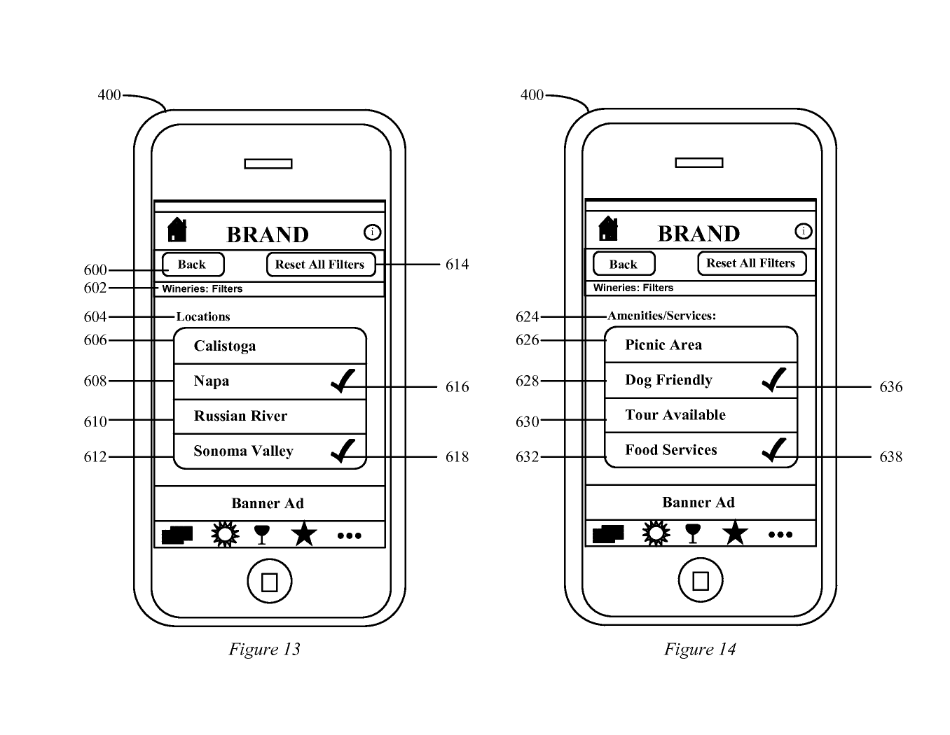

The filter definition can also specify the format of interface states used to output the filter settings. For example, in one embodiment, resources to use for each filter page, such as templates and image data can be specified which affect how the filter information is to be output. The navigation schema 26 determines how an interface state where the filter settings can be specified links to other states in the interface. Filters can be defined for a single field of data or multiple fields of data. In addition filters for SQL queries can be defined. An example of a filter for a wineries section of data including a single field match and multiple fields is shown below and illustrate with respect to FIGS. 13 and 14.

Below is example of code for two filters which can be included in an application database and which can be modified via an application database update. The first filter is applied to a single field in a record associated with wineries. The second filter uses multiple field matches. The allowed values for the second filter are entered as an ordered list. The field names point to fields in a record associated with the section of data. Examples of interface states used to configure these filters is discussed with respect to FIGS. 13 and 14.

| | |
|---|---|
| { “type” | : “single_field_match”, |
| “filter_name” | : “Locations”, |
| “page_name” | : “Wineries : Filters”, |
| “field_name” | : “location_area”, |

| | |
|---|---|
| “display_name” | : “Locations”, |
| “allowed_values” | : [“Calistoga”,“Napa”,“Russian |

| | |
|---|---|
| | River”,“Sonoma Valley”] |
| { “type” | : “multiple_field_match”, |
| “filter_name” | : “Amenities / Services”, |
| “allowed_tuples” : [ | |

| | |
|---|---|
| {“display_name” | : “Picnic Area”, |

| | |
|---|---|
| “field_name” | : “picnic_area”, |
| “value” | : “yes”}, |

| | |
|---|---|
| {“display_name” | : “Dog Friendly”, |

| | |
|---|---|
| “field_name” | : “dog_friendly”, |
| “value” | : “yes”}, |

| | |
|---|---|
| {“display_name” | : “Tour Available”, |

| | |
|---|---|
| “field_name” | : “tour_available”, |
| “value” | : “yes”}, |

| | |
|---|---|
| {“display_name” | : “Food Services”, |

| | |
|---|---|
| “field_name” | : “food_services”, |
| “value” | : “yes”}}] |

The application can be configured such that a number of filters and the definition of the filter can be changed without recompiling the application code. For example, in one embodiment, a local application database 54 can include the filter definitions above. In a subsequent update, the allowed values for the first filter can be changed. For example, the value, “Livermore,” can be added to the list “Calistoga”, “Napa”, “Russian River”, “Sonoma Valley” causing “Livermore” to be output as a filter option in FIG. 13. In another update, the first filter can be totally removed such that only the second filter is output. In yet another update, an additional filter can be added, such as a single value filter for whether a tasting room is offered or not. The server 12 can provide commands to the application 50 which allows these modifications of the local application database 54 to be implemented.

For other sections, filters can be specified in a similar format in the application database but the values may be different. For example, for a section of data including lodging information, the page name might be changed to “Lodging:Filters.” The filter may point to a similar field name, such as “locations_area” in a lodging section record if that field is included in the lodgings section. If the record is included in the lodgings section, it may not be in the same record location as in the wineries section. For example, in the wineries section it can be the seventh field in the record for the section and in the lodgings section it can be in tenth field of the record.

If the lodging section locations are organized in a similar manner as the wineries section, then similar values may be used for the filter (e.g., Napa, Calistoga, etc.) If the lodging section locations are organized differently than the values listed for the filters can be different. For example, more locations, less locations or different locations can be allowed for the lodging filter.

As described above, a version of the server application database 18 can reside on the mobile device 16 as the local application database 54. When the two databases are synced, the versions can the content of the databases may be the same. However, as the server application database 18 is updated, the two databases, 18 and 54, can diverge. In one embodiment, different databases can be maintained for different types of mobile devices. In particular, the resources specified for each type of mobile device can differ while the data in each section of the database can be the same. This feature allows output of content to be optimized for particular devices.

The application 50 can include a syncing component for performing syncs between the two databases. The database management component 62 can add or remove items from the database included but not limited to database content added or removed during syncs in response to commands from the server 12. For example, as described above, records can be specified with a time limit, such as a date range and the database management component can be configured to check and automatically remove records from the database for which the time limit is exceeded. This database maintenance feature may be implemented without instructions from the server. As another example, a resource available for generating an interface state can be added or removed in response to instructions from the server 12.

The page data gathering component 64 can be configured to retrieve information including data and coding instructions which allows an interface state associated with the application 50, such as a page output to a display on the mobile device 16, to be generated. The page data processing 66 can be configured to perform any processing of the information which enables the interface state to be generated, such as processing script language. The page assembly component 58 can be configured to assemble an interface state, such as page from the retrieved and/or processed information and output it to the one or more output devices (e.g., display, speakers, vibration device) coupled to the mobile device.

The page navigation component 56 can be configured to interpret information input into the mobile device, such as touch data input, in relation to the navigation structure specified in the application navigation structure. For example, the page navigation component can process touch input data or a voice command, determine a new interface state is to be generated and identify the new interface state that is to be generated. Then, the identified state can be generated and output on the mobile device.

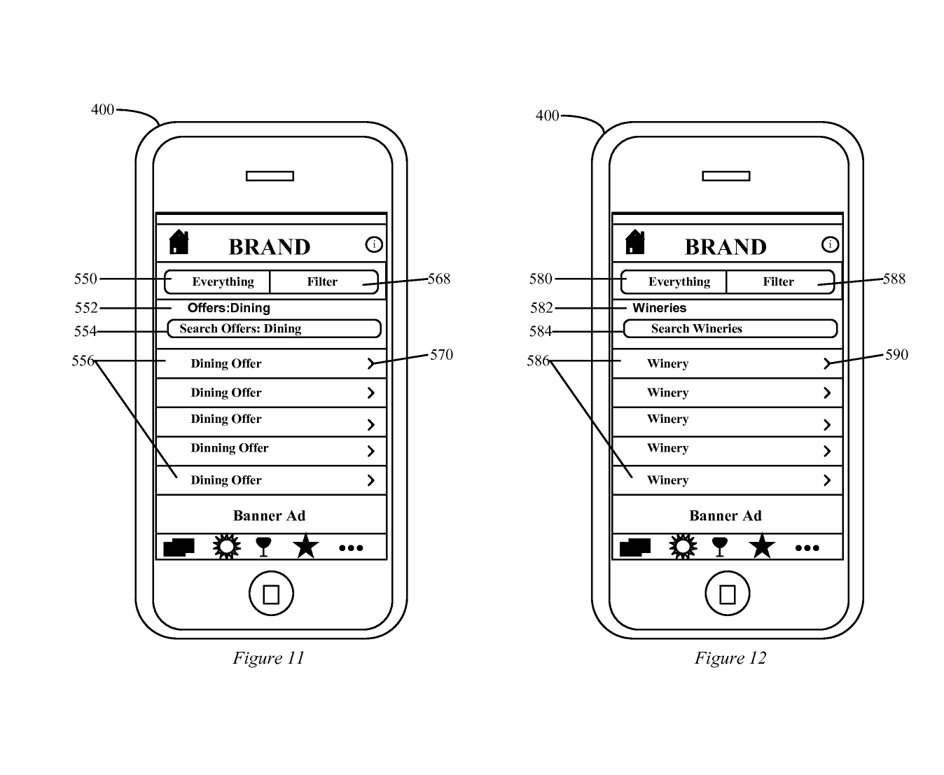

The search component can be configured to perform search queries of data residing within the local database 54. In one embodiment, the search may be performed only within one section of the database at a time, such as within the calendar section 38 or each of general sections, 40a, 40b and 40c. In another embodiment, two or more related sections of data in the database can be searched simultaneously. In one embodiment, to search a particular section, the application can be configured to allow a user to navigate to page which allows a search of the section. FIGS. 11 and 12, described below, illustrate examples of two pages with a search function.

In one embodiment, the mobile application 50 can include a statistics component (not shown). In one embodiment, when application is launched and network connectivity is available, the application 50 can be configured to transmit usage statistics. Examples of metrics which can be tracked include but are not limited a number of page views on a page by page basis, a number times the application has launched and a number of exits from the application to an outside application triggered within the application. For example, the number of requests to display a web-site associated with a particular winery can be tracked.

Typically, the components, such as, 56, 58, 60, 62, 64 and 66, are part of the application code and don't have to be recompiled when the local database 54 is updated. However, in some instances, it may be desirable to recompile the application code to add or remove some capability associated with these components. For example, the capabilities associated with processing a scripting language can be updated or an ability to process a new type of scripting language can be added. In one embodiment, this update can occur when a new version of the application is downloaded from the application store 14.

Next, additional detail of how the output of the application 50 can be modified in response to application database update is discussed with respect to FIG. 2. FIG. 2 is a block diagram of system where an output structure of a mobile application is modified via an application database update. In 1, the server 12 can upload a version of a mobile application to the application store 14, which acts as a code repository. As described above, server 12 can also be configured to directly download the application and bypass the application store 14. The uploaded application can include an application database as described above with respect to FIG. 1. The application at the application store can include a code version and an application database version.

The code repository, such as 14, can be maintained by an entity separate from the entity which provides the mobile application. The entity maintaining the code repository may review the mobile application before it is allowed to appear in the code repository. Thus, the entity providing the mobile application may not be able to control when the mobile application is made available. As described above, the review process can take days, a week or weeks. This review delay affects the ability to get time sensitive information out to users via code version updates.

After a version of code for the application and a version of the application database are uploaded, the server 12 can be configured to regularly change application database, such that the version of the application database changes over time. In one embodiment, the server 12 can be configured to periodically update the application database at the application store 14 without modifying the application code at the application store. In another embodiment, the server 12 can be configured to only update the application database at 14 at the same time a new version of the application code is updated. Thus, over time, the application database maintained on the server 12 can diverge from the application database at the application store 14.

In 2, the mobile device 16 can establish a communication connection with the application store 14. Then, a version of the application code with a version of the application database can be downloaded and installed on the mobile device 16. The application database can include information which specifies a number of interface states, types of interface states and a navigation structure between the different interface states that the application code can process and output. In addition, the content and format of each interface state when it is output can be specified within the application database. Thus, at a first time, the mobile device 16 can be configured to output content associated with the mobile application in accordance with a first structure 90a defined within the newly installed application code and application database downloaded in 2.

In 3, the mobile device 16 can establish communication with the server 12 and receive an update to the application database associated with the mobile application. For example, as described above, a syncing operation can be performed. The syncing operation can involve the mobile device 16 receiving commands and data which affect the structure and contents of the application database on the mobile device. Thus, at a second time, the mobile device 16 can be configured to output content associated with the mobile application in accordance with a second structure 90b defined within the newly installed application database. The section structure 90b can be generated without requiring the application code to be recompiled and reinstalled.

The differences between structure 90a and 90b can include but is not limited to a number of interface states which the application is configured to output, formats including possible formats in which interface state can be output, allowable transitions from one interface state to another interface state (e.g., navigation structure), a number of sections of data which are available for output, a type of data which is described in each section, filters which are available for each section of data, amount records available in each section (e.g., the section and its type of data may remain constant but existing records can be updated/removed and new records can be added) and resources which are available for constructing interface states (e.g., formatting instructions, pictures, text, data, etc.).

If desired, the differences implemented via the application database update can be significant enough such that the application at the second time appears to be a totally different application than the first application. For example, at a first time, the application database can cause the installed application code to output a travel focused content. At a second time, without changing the application code, an application update can cause a cooking focused content to be output, such as recipes associated with a region in which the user is traveling.

In one embodiment, the application code may allow for multiple application databases to be stored on the mobile device 16. For example, a cooking application database and travel application database can be maintained on the mobile device. As another example, application databases for two different travel regions can be maintained on the mobile device. The application code can include a feature which allows a user to select one of the available databases to use. In response, the content and features associated with the selected database are made available on the mobile device 16. As an example, a user can download two application databases to their mobile device, one for a first region in which they wish to travel and one for a second region in which they wish to travel. On one travel day, the user may cross from one region to another region and the application code can be configured to automatically switch databases or the user can input via the interface a command which causes the switch over to the new database.

### Application Navigation

In this section, some details and examples of an application navigation structure which can be specified via the application database. As described above, the application navigation structure defines the allowable transitions between different interface states which can be output using the mobile application. FIG. 3 is a block diagram of a navigation structure 100 for a mobile application.

In one embodiment, a single home page 102 can be defined for a visually formatted interface state. In general, a home interface state can be provided which doesn't necessarily include a visual component. In 100, each page includes a component which can cause the application to generate the home page. For example, FIGS. 7-16 includes a symbol of home which when selected cause the application to generate a home page.

In some examples, some of the pages can include a mechanism which triggers a pop-up to appear. A pop-up can be displayed over a page so that portions of the page are partially covered. The pop-ups can be somewhat transparent such that portions of the page which are underneath the pop-up are visible. A few examples of pop-ups that can appear from a home page are described with respect to FIG. 6.

In 100, pop-ups, 110, 120, 134, 150 and 162, are shown being generated in response to a detected input to the interface from the home page 102, the calendar section page 112, the section page 126, the section page 140 and the section page 154, respectively. In general, a pop-up can be triggered from any page. In one ne embodiment, the pop-up is not necessarily triggered from an input received via the interface. For example, the application may detect some event which causes a pop-up to be generated on the current page which is being output, such as a loss of a network connection. In this example, the pop-up can be generated on the current page which is being output when the event occurs. In another embodiment, a detection of an event can cause the application to generate a particular interface state, such as a home page, and then generate the pop-up related to the event.

When a pop-up appears, the interface may expect some input, such as a touch input, before the pop-up is dismissed. In one embodiment, the input may have to occur within the area of the pop-up. In another embodiment, the pop-up may be dismissed after some time period, such as a few seconds. In a particular embodiment, when the pop-up is dismissed, the page over which the pop-up is generated is displayed. Thus, the application can returns to the current page on which the pop-up is generated and a pop-up can't cause the interface to transition to another page. In another embodiment, a pop-up can include navigational links which cause the pop-up to be dismissed and a new page to be generated.

In one embodiment, a trigger for an information page 104 can be provided on each page. The information page 104 can include information about the application. In one embodiment, a template identifier and optionally an ad banner link can be specified for the information page in the application database. The template identifier points to a resource in the application database which is used to assemble the information page. In 100, the information page is shown linked to only the home page 102, settings page 106, calendar section page 112, and filter page 122. However, the information page link can be a requirement for each page except the information page 104. In one embodiment, the information page 104 is configured to only return the user to the page from which the link to the information page 104 was selected, such as from a first page to the information page and then back to the first page. In another embodiment, the navigation structure also allows a transition from a first page to the information page 104 and then to the home page 102.

The settings page 106 is configured to accept input which can cause settings associated with the application to be altered. In 100, a link is shown only from the home page 102 to the settings page 106. In other embodiments, a link to the settings page 106 can be specified on one or more of the other pages except the information page 104. One example of a user configurable setting is allowing the application to generate push notifications. In one embodiment, when push notifications are enabled, a remote server can initiate an application database update which is pushed out to one or more mobile devices. Another example of a user configurable setting is allowing the application to use location data available on the mobile device, such as GPS coordinates.

The favorites page 108 can include links to a record in a section of data which has been selected by a user. The links can be to records from multiple different sections of the application database. These links are referred to a leaf lists in FIG. 3. Typically, a leaf list is associated with only one section of data. However, leaf list associated with the favorites page 108 can be an exception.

A leaf list can include one or more pointers. Each pointer can point to a record in a section of the application database. Each pointer on the leaf list can be represented on a display page by one or more fields in the record to which it points. For example, a record in a wineries section can include a name of the winery and the pointer on the favorites page can be represented by the name of the winery.

A selection of the pointer on the page can cause the application to generate a page with more information about the record. In one embodiment, what information to use and what format to use for representing a pointer to a record in a leaf list can be specified for each section of the application database. Thus, a pointer to a record in the calendar section can be output on a page in a different format than a pointer to a record in the section associated with section page 126. When a leaf list is generated on the favorites page 108, each pointer in the leaf list can be represented in the format associated with the section in which it resides. In one embodiment, when the leaf list displays links to multiple pointers from the same section, these links can be grouped together. An example of a favorites page is described below with respect to FIG. 16.

The home page 102 includes an input mechanism which when triggered causes the favorites page 108 to be output. One or more of the other pages as is described below in more detail with respect to FIGS. 6-16 can include a mechanism for triggering an output of the favorites page 108. The favorites page 108 can be linked to a number of different leaf pages depending upon user selections. The user may be able to add or remove leaf pages from the favorites page. In one embodiment, the interface can include a mechanism which returns the favorites page to some default state, such as one where no links to leaf pages are displayed as part of a leaf list.

In one embodiment, the home page 102 can be configured to display selectable links to section pages or section list pages. In one embodiment, the section page can display a list of selectable pointers to records only in the section for which the page is associated. As described above, a favorites page is different because it can include pointers to records from multiple sections. The section list page can display navigation links to different section pages. The different section pages on a section list page can be related in some manner. For example, a section list page associated with “things to do” can point to different sections of data associated with different types of “things to do,” such as tours and attractions, grouped into two different sections.

The section list page can also display links to other section list pages. In one embodiment, the section list page may only display links to other section pages or section list pages but not to leaf pages. In one embodiment, the favorites page can be configurable to allow a user to specify section pages or section list pages for display on the favorites page.

Below is example code for a navigation list that can be included in an application database and modified via an update to the application database. In the example below, the page is linked to four child pages. More or less child pages can be used and/or altered in an update and this example is provided for illustrative purposes only. The format of a home page can be similar except the page is identified as a home page and hence is at the base or trunk of the navigation structure.

{

| | |
|---|---|
| “type” | : “navigation_list”, |
| “display_name” | : “Title used in grey bar”, |
| “link_name” | : “Title used for links coming from other pages”, |
| “tabbar_icon” | : “resource_id_for_icon_used_in_tabbar/iconbar”, |

| | |
|---|---|
| “icon_without_text” | : “resource_id_for_icon_without_text_used_in_navigation”, |

| | |
|---|---|
| “forward_icon” | : “resource_id_for_nav_arrow_used_on_text_links”, |
| “ad_banner_url” | : “url_for_bottom_of_page_ad_banner”, |

“children” : [“navigation_key_1”,“navigation_key_2”,“navigation_key_3”,

“navigation_key_4”

]

}

In one embodiment, links to leaf pages may not be allowed from the home page 102. In 100, the home page is linked to the calendar section page 112, the section page 126 and the section list page 138. Using an application database update, this navigation structure can be altered. For example, in an update, the section list page 138 can be removed such that section page 140 or section page 154 are reachable from the home page 102. In another example, via an update, an additional section of data can be added to the application database and the home page can be updated such that it includes a selectable link to a section page associated with the new section of data. In yet another example, the data section in the application database associated with the section page 126 can be removed, the link from the home page to section page 126 can be removed and all of the links underneath section page 126 can be removed.

In another embodiment, only the navigation structure that allows the display of the section page 126 can be removed preventing the data in the associated section from being displayed. Subsequently, the navigation structure can be modified to again allow the section page 126 and its associated data to be displayed. This feature may be useful if a particular section of data is temporarily not appropriate to output, such as a result of a weather condition or some event which renders the data as being not appropriate to output.

Each section page can display a list of links to pages each associated with a record in a section of data in the application database associated with the section page. The list of links is referred to as a leaf list. In 100, leaf lists, such as 116, 130, 144 and 158, are displayed on respective section pages, 112, 126, 140 and 154. A section page can also include links to filters. Depending on the parameters selected for the filters, different links can be displayed in the leaf list associated with each section page.

Below is an example of code used to generate a leaf list on a section page. Resource_id_{—}1 is a resource identifier to the template text resource used as a base for each line. As described above, the application database can store resources available for generating an interface state. Resource_id_{—}2 is a resource identifier used to display an individual page for a record represented in the leaf list (referred to as a leaf page). As described above, a default format for generating a leaf page can be specified for each section. However, as noted above, it is possible to use a custom template for generating a page including information from an individual record. In one embodiment, whether a custom template is to be used can be specified as a field in the record. Resource_id_{—}3 and Resource_id_{—}4 are identifiers to templates used to tell the user to page to the next or the previous n entries which are output in the leaf list, respectively.

| | |
|---|---|
| { | |
| ″type″ | : ″leaf_list″, |
| ″display_name″ | : ″Title used in display strip″, |
| ″link_name″ | : ″Title used for links coming from other pages″, |
| ″section″ | : ″Name of the database section associated with list″, |
| ″line_template″ | : ″resource _id_1” |
| ″leaf_template″ | : ″resource_id_2” |
| ″tabbar_icon″ | : ″resource id for icon used in tabbar/iconbar″, |

″icon_without_text″ : ″resource_id_for_icon_without_text_used_in_navigation″,

| | |
|---|---|
| ″forward_icon″ | : ″resource_id_for_nav_arrow_used_on_text_links″, |
| ″next_n_template″ | : ″resource _id_3”. |
| ″previous_n_template″ | : ″resource_id_4″, |
| ″n_per_page″ | : number_of_entries_per_page, |
| ″ad_banner_url″ | : ″url_for_bottom_of_page_ad_banner″, |
| ″leaf_ad_banner_url″ | : ″url_for_bottom_of_page_ad_banner_for_leaf_page″} |

A link to an icon bar, which can be displayed on a page, is referenced. An icon bar is shown on in FIGS. 7-16. The icon bar can provide navigation to a number of different interface states. An example of specifying the icon bar is shown below in the following code which can be included in the application database and can be modified via database update. The nav_entries point to different interface states and can cause the application to generate a specified interface state in response to detecting a selection of an icon associated with each state output to the display. Differ numbers of links and types of links can be specified and this example is provided for illustrative purposes only.

| | |
|---|---|
| {“type” | : “iconbar”, |
| “vertical-position” | : “bottom”, |
| “horizontal-position” | : “center”, |
| “nav_entries” | : [ “calendar”, “offers”,“wineries”,“favorites”,”more” ], |
| } | |

The filters for each section are referred as filter input/output. For example, filter I/O 118, 132, 148 and 160 associated with the calendar selection page 112, the section page 126, the section page 140 and the section page 154 respectively. Different mechanisms can be used to input or output information associated with the filters for each section. For example, a pop up format can be used or a separate filter page, such as 122, 136, 152 or 164, can be triggered from the section page. In some embodiments, multiple filter pages can be generated for a single section.

In 100, four sections each related to a section of data stored in the application database are shown. A section of data in the application database includes a common record format. One difference between the calendar section page 112 and the section pages 126, 140 and 154 is that some unique filters only available for filtering links in the calendar section of data are provided. For example, as shown in FIG. 7, a filter is provided that allows a user to select a day. Examples of filters for a general section of data are described with respect to FIGS. 13 and 14.

In one embodiment, the leaf list for each section page provides links to one or more leaf pages where each leaf page is associated with displaying information from a single record in the section. In 100, leaf list 116 displays links to leaf page 124a and 124b, leaf list 130 display links to leaf pages 136a and 136b, leaf list 144 displays links to leaf page 146a and 146b and leaf list 158 displays links to leaf page 166a and 166b. In one embodiment, only a single leaf page is output at one time. However, for a mobile device with a larger display, such as tablet, it may be possible to output multiple leaf pages simultaneously on different portions of the display.

For certain filter settings, there may be no links displayed in a leaf list. An example of a leaf page for a record in a calendar section of data is described with respect to FIG. 9. An example of a leaf page for a record in a general section of data is described with respect to FIG. 15.

Next details of the navigation structure for a leaf page are described with respect to FIG. 4. FIG. 4 is a block diagram of navigation structure 200 for a leaf page 202 in a mobile application in accordance with the described embodiments. As described a leaf page, such as 202, can be used to display a record in a section of data in the application database. In a tree structure analogy, the home page is analogous to a trunk or base of the tree and the leaf page is at the end of one or more branches (e.g., a section page or a favorites page). Thus, in one embodiment, navigation towards the trunk is only allowed from a leaf page. In addition, in some embodiments, an exit from the application can be provided from a leaf page. In one embodiment, for certain types of outside applications, links to the outside application are only displayed on leaf pages and are not available on type of pages, such as a home page or a section page.

In 200, the leaf page 202 is output with an icon bar 216. The icon bar includes selectable links to a calendar section page 218, a favorites page 220, a section list page 222 and a section page 224. A selection of one of these links causes the application to generate the interface state associated with the link. In addition, from the leaf page, selectable navigation links are provided to an info page 204 and a home page 206. In one embodiment, a link to one or more custom pages, such as 208, can be provided. For example, when the leaf page 202 is associated with a business, the custom page 202 can display offers associated with the business (e.g., see FIG. 15). The leaf page 202 includes a link back to the section page 210 from which the display of the leaf page was triggered.

In various embodiments, selectable links can be provided to outside applications. In one embodiment, a selectable link to a network location (e.g., a URL) can be provided as a banner ad. The selectable link can be displayed as an image. In one embodiment, the banner ad can be served from an outside source. Thus, an active network connection can be required to server banner ads. When the banner ad is selected, an exit from the application can occur. For example, a web-browser can be opened at an URL associated with the banner ad. In one embodiment, when a network connection is unavailable, a place holder image can be used. FIGS. 7-16 show examples of interface states including a banner ad.

In alternate embodiment, images and associated links for different ads can be stored in the application database where the ads can be updated via an update of the application database. The application code can be configured to serve these ads as banner ads on various interface pages. In one embodiment, when the mobile device is off-line, the links to an outside application are deactivated. In another embodiment, when the mobile device is off-line, a selection of the banner ad can cause a custom page associated with the banner ad to be generated. In yet another embodiment, a custom page can be generated after a detection of a selection of a banner ad. In one embodiment, the custom page can include a selectable link to an outside application which causes an exit from the application.

As described above, a number of links 214 can be provided to outside applications (e.g., see FIGS. 9 and 15) Links to a mapping application 226, a phone application 228, a web-browser application, a social media application and a generic application 234 are shown. When one of the links is selected, the outside application can be activated and an exit can occur from the mobile application. In one embodiment, a pop up can be generated with a message indicating the user is leaving the application and optionally a selectable indicator can be provided that verifies the user wishes to leave the mobile application. The mobile application can be configured to save the exit point so that the next time the application is opened it starts on the page from which it exited. The selectable links to outside applications which are available on a particular leaf page, such as 202, can be changed via an update of the application database.

In particular embodiments, when an outside application is invoked, it can be passed information from a record in one of the sections. For example, if the leaf page is associated with a winery, the mapping application 226 can be passed coordinates of the winery, the phone application 228 can be passed a phone number associated with the winery, the web-browser 230 can be passed a URL for a web-site associated with the winery and generic application can be passed some information from one of the fields associated with the winery record. The social media application 232 can be passed information which allows one or more of a) the user to locate information about the winery on the wineries social media site, b) establish a relationship between the user and the winery (e.g., follow the winery on Facebook™ c) post information to their account about winery (e.g., images and text associated with the winery as part of a status update) or d) perform any other activities associated with a social media account.

One or more of the applications may not be invoked depending on the types of network connections available on the mobile device. For example, when the mobile device includes cellular communication access but not data access only the phone application may be available. In an output page, some indicator can be provided that the application is not available. For example, an off-line message or a circle with a slash through it can be displayed over an icon representing the application.

In one embodiment, the application can include some native mapping capabilities. For example, the application can include local and regional maps. When no network access is available and the map application is selected, the application can be configured to display a map with an indicator of a location associated with the record using a map available from the mobile application. If a current location of the mobile device can be determined in some manner, then an indicator of the current location of the user can also be displayed on the map which is output.

As described above, some outside applications may only be available from certain interface states. In one embodiment, since the outside applications utilize information from a particular record in a section of data, the links to the outside application may only be made available when a particular record has been selected for display. In this example, a leaf page, such as 202, is displayed when a particular record is selected. Thus, selectable links to outside applications using data from the record can also be output with the leaf page.

In other embodiments, when the application receives an indication of a selection of a particular record, a mechanism can be provided which allows access to outside applications using information from the particular page. For example, a link to a custom page can be provided. When the link to the custom page is selected, a custom page can be generated which displays a number of outside applications which can be invoked with relevant information from the particular record which is selected.

Next, with respect to FIG. 5, an example of a navigation structure for a travel application is described. In 300, a travel application home page 302 is defined. Each of the other pages, besides the home page, include navigation links to the home page 302. The home page 302 is at the trunk of the navigation structure defined in the application database. One or more pop-ups 310 can appear from the home page. For example, pop-ups indicating the availability of various network connections can appear when application are first started and the home page is displayed (e.g., see FIG. 6).

In another embodiment, the pop-ups can appear on whichever page the application initially displays. For example, as described above, when an outside application is invoked, the application can be configured to start from the page from which the application was exited. Thus, the pop-ups can appear on the exit page.

The home page is linked to an information page 304, a settings page 306 and a favorites page 308. These pages may also be reached from other pages. For example, the information page 304 can be reached in response to an icon which is displayed on each page. Whereas, when an icon bar is displayed on a page, the settings page 306 and/or favorites page 308 can be reached via a selection of an icon associated with each page.

The travel home page displays links to a calendar section page 112, a winery section page 324 and a “things to do” navigation list page 334. When calendar page link is selected from the home page 302, the calendar page 312 can display selectable links for filter options 314 and a leaf list of one or more events 316 (or no events depending on the filter settings, such as a date range). In the example, links to two events are displayed. When the first link or the second link is selected, the event pages 322a or 332b are generated, respectively.

The filters 314 on page 312 includes selectable links to pop-ups and links to pages which allow filter setting to be altered. When the pop-up link is selected, a pop-up 318 is generated over the calendar page 312. When application detects the filter page link is selected, a new interface state including the filter page 302 is generated.

Returning to the home page 302, when the application detects a winery link has been selected on the home page 302, the application can generate winery section page 324. The winery section page 324 can include a leaf list 328 which displays information as part of a selectable links for wineries associated with records in the winery section of the application database. As an example, a selectable link output to the page can include a name of the winery. In 300, selectable links to two wineries are shown on page 324, for the purposes of illustration as more or less links can be displayed. When the first link or second link is selected, a leaf page 332a or 332b for the first or second winery is generated.

The winery section page 324 displays one or more links to filters. As described above, the filters can be defined in the application database. When one of the links are selected, a winery filter page 330 can be generated. This page may include links to other filter pages.

Returning to home page 302, when the application detects a selection of a link to the things to do list page, the “the things to do” section list page 334 can be generated. In this example, page 334 displays two selectable links to a tours/sightseeing section page and a golf section page 352, respectively. More than two links can be displayed and the example of two links is provided for the purposes of illustration only.

When a selection of the tours/sightseeing section page is detected, a leaf list 344 and filter links 342 are displayed on the page 340. In example, links which cause a tour leaf page 348a or a sightseeing leaf page 348b to be generated are output. When the filters link is selected, a tour/sightseeing filter page 346 is generated.

When a selection of the golf section page is detected, a leaf list 354 and filter links 354 are displayed on the golf section page 352. In the example, links which cause a first golf leaf page 360a or a second golf leaf page 360b to be generated are output on page 352. When the filters link is selected, a golf filter page 358 is generated. The golf filter page 358 can include selectable filters such as whether club rental or a driving range is available at the golf course.

In other embodiments, links to another page which list additional sections can be provided from a section page, such as 334. For example, the tour and sighting data can be split into different sections. The split allows for the record formats between the two sections to be different. For example, one section can have records with more fields and fields of different types than the other section.

In this example, rather than linking to the tours and sightseeing page 340, a link to a page which displays a link to tour section page and a link to a sightseeing section page can be displayed. When the link to the tour section page is selected, a tour section page is generated which display a list of links to tours associated with records in the section. When the link to the sightseeing section page is selected, a sightseeing section page is generate which displays a list of links to sightseeing activities associated with records in the section.

Examples of Interface States from a Mobile Travel Application

In this section, examples of interface states and some features associated with the interface states are described. In alternate embodiments, the described features can be mapped to different interface states than shown in the Figures. Thus, the examples are provided for the purposes of illustration only and are not meant to be limiting.

FIG. 6 is an illustration of a home page of a travel application output on a mobile device 400 in accordance with the described embodiments. The home page is output on a display associated with the mobile device. Each of the elements of the home page which are output can be specified in the application database. In 410, the mobile application can be branded using text or image data. The brand can be the name of the company which provides or sponsors the mobile application.

To right of the brand 410, an icon 402 with an “i” in a circle is shown. When the application detects a touch near the area of the icon 402, an information page can be generated. An image 412 can be provided beneath the brand. The image 412 may be an image associated with the application. For example, if the application is a travel application, the image can be from the region where the travel application covers.

A star icon 414 is displayed, which is mapped to the favorites page. A calendar icon 416 is displayed which is mapped to a calendar section page. A sun icon 418 is displayed which is mapped to offers. A glass icon 422 is displayed which is mapped to wineries. A fork and knife icon 422 is displayed which is mapped to dining. A building icon 424 is displayed which is mapped to lodging. A finger pointing icon 426 is displayed which is mapped to “things to do.”

These icons can appear on an icon bar as will be described in the following figures. In one embodiment, the categories can extends beyond what is shown and the user can interact with an input mechanism on the device 400, such as the touch screen to cause different categories to be displayed. For example, an interaction with the device can cause the list of categories to move up where the favorites disappears, the remaining categories move up and a new category appears below the “things to do.” This approach can also be used to scroll through a leaf list displayed on a section page.

A selection of the arrow, such as 428, next to the favorites can cause the application to generate a favorites page and a selection of the arrow next to the calendar can cause a calendar section page including a leaf list of event data to be displayed. A selection of the arrows next to offers, wineries, dining, lodging or “things to do” can cause the application to generate one of a section page or a page with a list of sections associated with the category. For example, a selection of the arrow next to offers (and/or in the area between the lines where the offers is located) can cause the application to generate a list of offers sections, such as offers/dining, offers/lodging and offers/wineries. As another example, a selection of the arrow next to offers can cause a section page for the offers section to be generated which includes a leaf list for all of the offers. If enabled, using filters, the offers can be narrowed down, such as to display only the dining offers or wineries offers.

When the application is first launched, the application can determine whether access to a network connection, such as an interne connection is available. If the mobile device offline, the pop-up 404 can be generated. A detection of a selection of the go online button may cause the mobile device to generate an Internet connection or place itself in a state where the user can cause an Internet connection to be generated. For example, the mobile device can display a settings page where airplane mode can be turned off so that an Internet connection can be established. A selection of the “use last info” button can cause the application to use the information which is currently available in the local application database. In one embodiment, each time the application is launched it can attempt to contact a remote server and engage in a sync operation to update the local application database as needed.

In one embodiment, when the mobile device is determined to be on-line, the pop-up 406 can be displayed. The pop-up 406 requests the user to indicate whether the application can use location data available on the phone. This feature can also be adjusted via a settings page provided within the application. In another embodiment, if the user allows for location data to be used in 406, a pop-up 408 can be generated. The pop-up 408 can request the user to indicate whether the application can send push notifications based upon their location. In one embodiment, when push notifications are enabled a remote device can initiate a sync operation on the mobile device.

In one embodiment, a pop-up (not shown) can appear which allows a user to login to the application via a social media account, such as their Facebook™ account. When the user logins in via their social media account, the application can gather information about the user, such as profile information from their social media account. A login via their social media account can be taken as indication the user is allowing the application to retrieve information from the account associated with the social media application. Alternatively, a pop-up can be displayed which allows the user to confirm this decision.

In one embodiment, when the user logins via their social media account, the application can provide special features, such as direct posts to their account, via a selection of link in an interface. Further, the application can be configured to provide special offers for user's which login using their social media account. In one embodiment, the application can be configured to allow the individual earn points for posting information to their social media account. For example, the user can tweet that they are enjoying themselves at a particular winery. Depending on the number of their followers, the user may be able to earn a certain number of points which can be redeemed for an award. For example, a discount coupon can be offered from the winery that was mentioned in the tweet.

FIG. 7 is an illustration of a calendar page of a travel application output on a mobile device 400 in accordance with the described embodiments. The page includes an icon 450 of a building. A selection of the building can cause the application to return to the home page. The page includes three buttons, 452, 470, and 472, related to filters. A selection of the “everything” button causes the application to output all calendar events without filtering. A selection of the filter button 470 causes the application to generate one or more pages which allow the user to input setting which affect what event data is listed, such as only certain types of event. A selection of “choose day” button 472 cause the application to generate a page for selecting a day which is discussed with respect to FIG. 8.

In one embodiment, the event data is listed according to day. For example, strips 454 and 456 including the text “day#1” and “day#2” are displayed. A list of three events 456 is shown beneath strip 454 and a list of three events 460 is shown beneath strip 458. The interface may be configured to accept inputs which cause the days to scroll such that different dates and associated events are displayed. A selection of an arrow, such as 474, next to an event can cause the application to generate a leaf page including the event data (e.g., see FIG. 9). In particular embodiments, All or a portion of these components, such as how the strips 454 and 456, are output can be altered via an update to the application database.

Examples of information which can be displayed for each event in the leaf list can be a name, a time and a cost. This information is included in the record associated with event. Different fields can be selected from the record as specified in the application database. In one embodiment, when location information about the mobile device's current location is available to the application, the events for each day can be sorted according to a distance from the location of the mobile device. This distance may be displayed next to each event. In other embodiments, the events for each day can be sorted according to price, by time, alphabetically or some other sorting parameter.

A banner ad 462 is output beneath the list of events. In one embodiment, when a banner ad is selected, a web-browser can be opened at a URL associated with the banner ad. The ads can be served from a remote device. In another embodiment, the ads can be served from the local application database. In addition, as described above, a selection of a banner ad can cause the application to generate an interface state with additional information associated with ad, such as an ad page. When the mobile device is off-line, such that access to an outside application like a web-browser is unavailable, a place holder image can be displayed instead of the banner ad. In on embodiment, the place holder image may indicate the device is off-line.

Beneath the banner ad, a number of icons, 464, 466, 468, 476 and 478 are displayed. Icons 464, 466, 468 and 478, are associated with the categories displayed on the home page in FIG. 6. A selection of one of these icons can cause the application to generate the same page that is generated when the category associated with the icon is selected on the home page. A selection of the icon 476 of the three dots can cause the application to display additional icons for selection on the icon bar. In one embodiment, the interface may allow the user to accept input which causes the icons to scroll left or right such that different icons are displayed.

FIG. 8 is an illustration of a page of a travel application output on a mobile device 400 in response to a selection of the choose day button 472 in FIG. 7 in accordance with the described embodiments. A month and year 500 and days for the month, such as 504, are output. The interface is configured to receive a selection of a day, such as 506, or a range of days (not shown). Via arrows, such as 502, the user can select a month. When the application returns to the calendar section page in FIG. 7, the day or days and the events associated with the selected days can be output.

FIG. 9 is an illustration of an event page of a travel application output on a mobile device 400 in accordance with the described embodiments. The template to use for the event leaf page can be specified when the format for the calendar section page (see FIG. 7) is specified. The template to utilize can be specified via the application database. Different templates with a different output format and information which is shown are possible and this example is for the purposes of illustration only.

The application can generate the event leaf page in response to a selection of one of the events from calendar event page in FIG. 7. A selectable back button 510 is output. A selection of the button causes the page from which the event is selected to be generated (e.g., FIG. 7). The template is used to output a strip 512 including calendar event. A name 514a, date 514b, time 514c, phone 514d, fee 514e and location 514f are displayed. The application can retrieve this information from the record in the calendar section of the application database associated with the event.

Beneath the event information, buttons, 516, 520, 522 and 524, are displayed. A selection of any of the buttons can cause and outside application to be instantiated. For example, a selection of button 516 can cause a mapping application, such as Google™ maps to be instantiated using a location associated with the event included in the event record. A selection of the call button 520 can cause a phone application to be generated using a phone number associated with the event. A selection of the web-site button 522 can cause the application to trigger launch of a web-browser application at URL associated with the event. A selection of the share button 524 can trigger a launch of a social media application with some information about the event included. For example, the user can share details of the event with their friends via a social media account post. As described above, when application is to be exited, the application can generate a pop-up with information warning the user about the exit.

One or more of the outside application may not be available for different reasons. For example, the applications may not be available because of a network connection status. In another example, an application may not be available because there is insufficient information, such as a phone number is unavailable. When application is unavailable, in one embodiment, the application can output a visual indicator of the application status. In another embodiment, the application can generate a message of the unavailability of the outside application when it is selected.

A detailed description 518 is displayed beneath the outside applications. In one embodiment, the interface can accept inputs which cause the event information to scroll up/down so that more information can be displayed. For example, the interface can be configured to receive inputs, which causes the event data to scroll up such that the more detailed information about the event can be viewed.

FIG. 10 is an illustration of a page with offer categories from a travel application output on a mobile device 400 in accordance with the described embodiments. A strip 530 with offers is output at a top of the page. Beneath the strip 530, the categories all 532, dining 534, wineries 536, lodging 538, things to do 540 and 542 shopping are displayed. A selection of the “all” category 532 via arrow 544 can cause the application to generate a page with a list of offers from all of the categories. A selection of one of the other pages can cause the application to generate a page with offers associated with the selected category.

FIG. 11 is an illustration of a page with a listing of dining offers from a travel application output on a mobile device 400 in accordance with the described embodiments. The page is a section page listing dining offers. As an example, a selection of the dining category 534 in FIG. 10 can cause the application to output this section page.

The section page includes two filter buttons, “everything” 550 and “filter” 568. A selection of the “everything” button 550 can cause the application to list all of the dining offers. A selection of the “filter” button 568 can cause the application to generate pop-ups or pages which allow filter settings to be configured. After the filter settings are selected, the list of dining offers can be output according to the selected filter settings.

Beneath the filter buttons, a title 542 for the page, “Offers:Dining” is output. Beneath the title, a text input area 554 is provided for inputting search terms. The search terms can be constructed as a database search query, such as an SQL (Structured Query Language) query. The search terms can be used to search among the dining offers in the section of data in the application database associated with the dining offers. Information about the records located according to the search parameters can be displayed beneath the search input area 554. In one embodiment, searches are only allowed among a single section of data. Thus, the search function is only displayed when a particular section of data has been selected for output. Beneath the search input area 556, six dining offers are listed. A selection of one of the offers, such as via arrow 570, can cause the application to output a leaf page for the selected dining offer (e.g., FIG. 15 is an example of a leaf page).

FIG. 12 is an illustration of a page with a listing of wineries from a travel application output on a mobile device 400 in accordance with the described embodiments. The page is similar to the offers dining page in FIG. 11 except the subject matter is different. The page includes an “everything” button 580 which when selected prevents filtering, i.e., everything is displayed. A selection of “filter” button 588 causes the application to generate pages for setting winery filters. A few examples of winery filter pages are described as follows with respect to FIGS. 13 and 14.

A title 582 for the page, “wineries” is output. Beneath the title, an input area is provided which is configured to accept text input for searches within the wineries section of data. Entries 586 for six different wineries are listed. A selection of one of the entries, such as via arrow 590, can cause the application to generate a winery leaf page for the selected entry (e.g., see FIG. 15).

FIG. 13 is an illustration of a first page which allows adjustment of filter settings associated with wineries from a travel application output on a mobile device 400 in accordance with the described embodiments. The page includes a button 600 for returning to the previous page. A selection of button 614 causes the application to set the filter settings to a default state, such as all of the locations selected.

A title for the filter is displayed in a strip 602. In this example, the title is wineries filters 602. Beneath the title, a field of data from a record associated with the wineries section of data is displayed. In this example, the field is location 604. The filter allows the user to select from among four locations, Calistoga 606, Napa 608, Russian River 610 and Sonoma Valley 612. In this example, check marks 616 and 618 are shown next to the Napa 608 and Sonoma Valley 612 locations are checked. The checks can mean something affirmative, such as only filter for these locations, or non-affirmatives, such as filter out these locations, depending on how the filters are constructed.

FIG. 14 is an illustration of a second page which allows adjustment of filter settings associated with wineries from a travel application output on a mobile device 400 in accordance with the described embodiments. This filter is based on the field titled “Amenities/Services.” For choices are listed for the filter, “picnic area” 626, “dog friendly” 628, “Tour available” 630 and “Food services” 632. This information can be specified in different fields associated with a winery record in a winery section of the database. In the example, the “dog friendly” 628 and “Food Services” 632 options are selected as indicated by checkmarks, 636 and 638, respectively. Again, a selection can indicate something affirmative or non-affirmative depending on how the filter is configured.

FIG. 15 is an illustration of a page, including winery information and a navigation link 656 to offers associated with the winery, from a travel application output on a mobile device 400 in accordance with the described embodiments. As an example, the page can be displayed response to one of the wineries listed in FIG. 12. A button 650 is provided which causes the application to return to the page which listed the wineries.

A selection of the offers button 656 can cause a page to be generated which displays offers associated with record output in the leaf page. In this example, the offers may be associated the particular winery. In some embodiments, no offers may be available. For the winery leaf page, a name 652a, a phone number 652b, whether a tasting room is present 652c, hours 652d, cost 652c and location 652e can be output. If the record is incomplete, one or more of the fields can be blank. A detailed description 654 about the winery is displayed at the bottom of the page. The interface can be configured to accept inputs which cause the page to scroll up allowing the detailed description to be viewed.

FIG. 16 is an illustration of a favorites page from a travel application output on a mobile device 400 in accordance with the described embodiments. The favorites page includes a back button 660 which can cause the application to generate the page from which the favorites page was selected. The edit button 678 can allow user to remove one or more selected favorites from the page. Whenever a leaf page is generated, a link can be provided on the page which when selected causes the application to add it to the favorites or initiate a mechanism which allows it to be added to the favorites.

A strip 662 including the title favorites is output on the page. Beneath the title a leaf list is output with leaf entries from different sections of the application database. In this example, favorites from three sections, calendar of events for date 664, wineries 670 and offers dining 674 are output. Under each section, selected items are listed. For example, an event 668 is listed under section 664, a winery 672 is listed under section 670 and two dining offers 676 and 678 are listed under section 674.

Embodiments of the present invention further relate to computer readable media that include executable program instructions for performing recruiting techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

1. A non-transitory computer readable medium for storing a computer program used by a mobile device, the computer program executed by a processor on the mobile device to generate a travel application, the computer readable medium comprising:
computer code for generating a plurality of interface pages for the travel application which are output on a touch screen display of the mobile device using only information stored locally in a travel application database in a memory on the mobile device wherein the travel application database is initially downloaded from a third-party code repository, said travel application database including:
an output structure used to generate each of the plurality of interface pages output via the travel application wherein the output structure specifies at least a location of content and a location of at least one touch screen button on each of the plurality of interface pages wherein a selection, via the touch screen display, of the at least one touch screen button on each of the interface pages causes a different one of the plurality of interface pages to be output to the touch screen display;
a navigation structure which identifies the different one of the plurality interface pages associated with each of the at least one touch screen buttons such that a set of interface pages which are available to output in response to user selections via the touch screen display are defined;
a plurality of resources including electronic media files and templates in a scripting language used to generate the output structure for each of the plurality of interface pages;
a plurality of travel data sections each travel data section including records associated with a category of travel related information and information specifying filters for use only with the records in the travel data section wherein the navigation structure specifies a portion of the records from which data is available to output in response to the user selections via the touch screen display;
computer code for syncing, without recompiling or reinstalling the travel application on the mobile device, the travel application database stored on the mobile device with a remote travel application database stored on a server maintained separately from the code repository wherein between syncs the travel application database remains fixed such that the set interface pages which are available to output in response to user selections via the touch screen display remains fixed; and
computer code for performing a first sync, wherein only the navigation structure in the travel application database is altered during the first sync wherein prior to the first sync a first set of interface pages is specified such that a first portion of the records is available to output in response to the user selections and wherein after the first sync a second set of interface pages is specified, different from the first set, such that a second portion of the records, different from the first portion, is available to output in response to the user selections.

2. (canceled)

3. The computer readable medium of claim 1, further comprising computer code for adding or removing a resource from the travel application database in response to instructions received from the server in the syncing.

4. The computer readable medium of claim 1, wherein the electronic media is one of an image file, an audio file, a video file or an audio/video file.

5. The computer readable medium of claim 1, further comprising computer code for interpreting the one or more scripting languages used in the travel application database.

6. The computer readable medium of claim 1, further comprising computer code for interpreting electronic media file formats used for the electronic media files stored in the travel application database.

7. The computer readable medium of claim 1, further comprising computer code for sending mobile device capabilities including a display capability and computer code for receiving electronic media from the server selected for compatibility with the mobile device capabilities.

8. The computer readable medium of claim 1, further comprising computer code for adding or removing all or a portion of the navigation structure from the travel application database in response to receiving instructions from the server in the syncing.

9. The computer readable medium of claim 1, further comprising computer code for removing an existing resource from the travel application database or adding a new resource in response to receiving instructions from the server in the syncing.

10. The computer readable medium of claim 1, further comprising computer code for removing an existing travel data section or adding a new travel data section from the travel application database in response to receiving instructions from the server in the syncing.

11. The computer readable medium of claim 1, further comprising computer code for updating the navigation structure to remove navigation links to the existing travel data section which is removed or add navigation links to the new travel data section which is added.

12. The computer readable medium of claim 1, further comprising computer code for removing an existing filter associated with one of the travel data sections or adding a new filter associated with the one of the travel data sections in the travel application database.

13. The computer readable medium of claim 12, further comprising computer code for updating the navigation structure to remove a navigation link to an interface page which allows settings for the existing filter to be specified or add a navigation link to an interface state which allows settings for the new filter to be specified.

14. The computer readable medium of claim 1, wherein the travel application database further comprises information specifying a structure of the travel application database including a number of travel data sections, a number of fields in the records in each of the travel data sections, a description of each of the fields for the records in each of the travel data sections and a number of records in each of the travel data sections.

15. The computer readable medium of claim 1, further comprising computer code in response to the instantiation of the travel application on the mobile device, sending a sync request to the server to update the travel application database on the mobile device.

16. The computer readable medium of claim 15, further comprising computer code for determining sync is not possible with the server and outputting a message indicating the travel application is using the not synced data currently residing in the travel application database.

17. The computer readable medium of claim 1, further comprising computer code for configuring the travel application to allow the server to initiate the syncing to update the travel application database.

18. The computer readable medium of claim 1, wherein a default template is specified in the travel application database for outputting each record in each travel data section wherein the default template is variable from travel data section to travel data section.

19. The computer readable medium of claim 18, further comprising a field in a record associated with one of the travel data sections wherein in the field a custom template is specifiable for outputting the data in the record different from the default template.

20. The computer readable medium of claim 1, wherein a time is specified with the records in one of the travel data sections further comprising computer code for determining whether to output or not output information from the records based upon the time.

21. The computer readable medium of claim 1, wherein a time is specified with the records in one of the travel data sections further comprising computer code for determining whether to delete one of the records from the application database based upon the time.

22. The computer readable medium of claim 1, further comprising computer code for sending a version number of the travel application database to the server and in response, receiving an incremental update of the travel application database from the server based upon the version number sent to the server including a new version number for the travel application database.

23. The computer readable medium of claim 1, further comprising computer code for sending a version number of the travel application database to the server and in response, replacing an existing version of the travel application database with a new version of the travel application database, which is received from the server, based upon the version number sent to the server.

24. The computer readable medium of claim 1, wherein each record in one of the travel data sections includes a field for specifying a location further comprising computer code for receiving location data associated with the mobile device and outputting a list of records from the one of the travel data sections sorted according to a distance from the mobile device to the location associated with each record in the list of records.
